(19) United States
(12) Patent Application Publication
(10) Pub. No.: US 2008/0156354 A1
(43) Pub. Date: Jul. 3, 2008

(54) SYSTEM AND METHOD FOR CLEANING CATALYTIC CONVERTER

(75) Inventors: Terri Lea Mackey, Coffeen, IL (US); Steve Shoemaker, Hillsboro, IL (US)

Correspondence Address: SENNIGER POWERS LLP, ONE METROPOLITAN SQUARE, 16TH FLOOR, ST LOUIS, MO, 63102, US

(73) Assignee: AMEREN CORPORATION, St. Louis, MO (US)

(21) Appl. No.: 11/955,819

(22) Filed: Dec. 13, 2007

Related U.S. Application Data
(60) Provisional application No. 60/882,919, filed on Dec. 30, 2006.

(51) Int. Cl. B08B 3/10; B08B 13/00; B08B 9/027; F16B 45/00

(52) U.S. Cl. 134/22.18; 134/201; 134/137; 134/23; 248/304

(57) ABSTRACT

A cleaning system for removing contaminants from a catalytic converter includes a vibrator for vibrating the catalytic converter when the converter is placed in a cleaning liquid. The vibrator is mounted on a lift-connector of the system. The lift-connector defines a pair of forklift-openings for receiving forks of a forklift.

### CROSS-REFERENCE TO RELATED APPLICATION

The present application claims priority to U.S. Provisional Application No. 60/882,919, filed Dec. 30, 2006, the entirety of which is herein incorporated by reference.

### FIELD OF THE INVENTION

The present invention generally relates to a system for removing contaminants from a catalytic converter and a method of doing the same.

### BACKGROUND OF THE INVENTION

Industrial plants that use combustible fuels, such as coal or other fossil fuels, to power their operations are required under both federal and state law to meet clean air emission requirements. Typically, catalysts are used to remove certain products from emissions of industrial plants before the emissions are released into the environment. For example, in a process called selective catalytic reduction, also known as SCR, nitrogen oxides are converted into nitrogen and water using a device called a catalytic module, also known as a catalytic converter.

Referring to FIGS. 1 and 2, a typical catalytic converter used in SCR is generally indicated at 10. The converter includes a housing 12 that is generally rectangular in section and includes four side walls 14 (only two side walls are visible in FIG. 1) and opposite, open ends 16 (only one open end is visible in FIG. 1). Within the housing 12 are generally elongate catalyst members (sometimes referred to in the art as logs), generally indicated at 18, arranged in a grid-like configuration (FIG. 1) and extending between the open ends 16. Each catalyst member 18 comprises a plurality (e.g., 484) of catalyst channels 20 (FIG. 2) extending lengthwise of the catalyst member generally between the open ends 16 of the housing 12. In use, the catalytic converter 10 is placed in a flue gas duct and orientated so that the open ends 16 are generally in the path of flue gas traveling to the stack. Depending on the orientation of the converter 10 in the gas path, one of the open ends 16 constitutes an inlet through which flue gas enters the converter and the other open end constitutes an exhaust through which cleaner gas exits. As the gas travels through the catalyst channels 20, nitrogen oxides (NO_{X}) in the gas react with chemicals on the surface of the catalyst members 18 and convert the NO_{X} into nitrogen and water. The flue gas continues through the channels 20 and passes through the exhaust (i.e., the opposite open end) of the converter 10.

A major problem associated with using the catalytic converter 10 to remove nitrogen oxides from fossil fuel emissions is the build up of fly ash and other contaminants, such as popcorn ash, in the converter. Fly ash, popcorn ash and other contaminants entrained in the flue gas can become lodged in the catalyst channels 20 as the flue gas passes through the converter 10, blocking the channels and preventing gas from passing through the channels. Over time, fly ash and other contaminants become lodged in a majority of the catalyst channels 20 of the converter 10, significantly hindering the performance of the converter.

### SUMMARY OF THE INVENTION

In one aspect of the invention, a device for use in cleaning a catalytic converter of the type used in power plants generally comprises a fixture adapted for securement to the catalytic converter. A vibrator mounted on the fixture imparts vibratory movement to the fixture and to the converter when the fixture is secured to the converter.

In another aspect, a lift-connector for use in securing a catalytic converter of the type used in power plants to a forklift generally comprises a fixture adapted to be secured to the catalytic converter and to the lift device for use in lifting the catalytic converter. The fixture defines a pair of spaced apart fork-openings. Each fork-opening is sized and shaped for receiving a fork of a forklift.

In yet another aspect, a cleaning system for removing contaminants from a catalytic converter generally comprises a tank for holding cleaning liquid. The tank is sized and shaped to allow a catalytic converter to be placed in the liquid in the tank. A vibrator is adapted for operative connection with the converter to impart vibratory movement to the converter when the converter is placed in the liquid of the tank to facilitate removal of the contaminants from the converter.

In another aspect, a method of removing contaminants from a catalytic converter having catalyst members defining a plurality of catalyst channels generally comprises placing the catalytic converter in a tank of liquid. The catalytic converter placed in the tank is vibrated to loosen the contaminants from within the catalyst channels.

Other features will be in part apparent and in part pointed out hereinafter.

### BRIEF DESCRIPTION OF THE DRAWINGS

FIG. 1 is a perspective of a catalytic converter for use in a power plant;

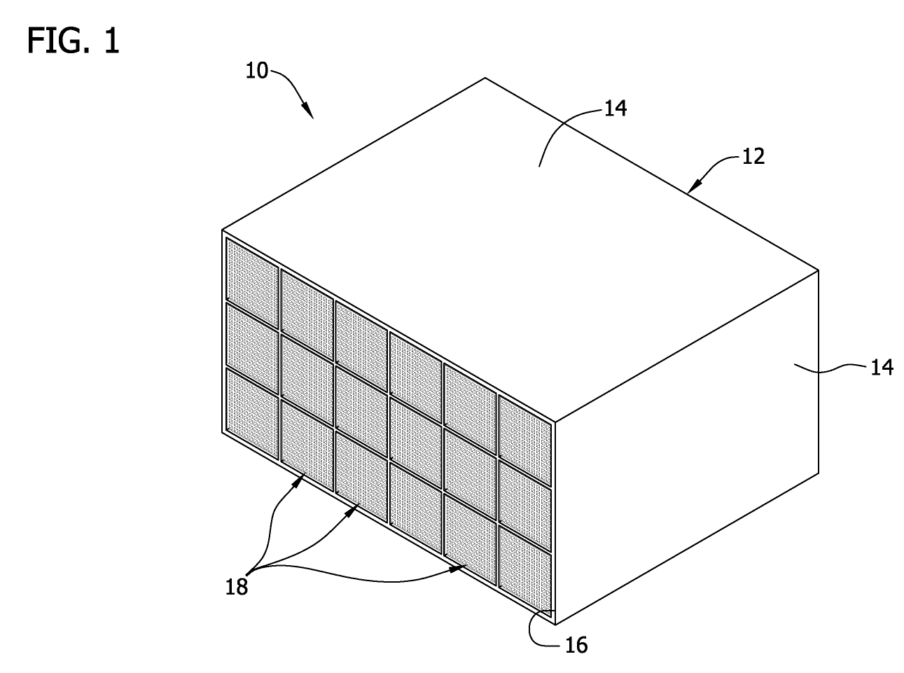

FIG. 2 is a fragmentary perspective of an individual catalyst member of the catalytic converter;

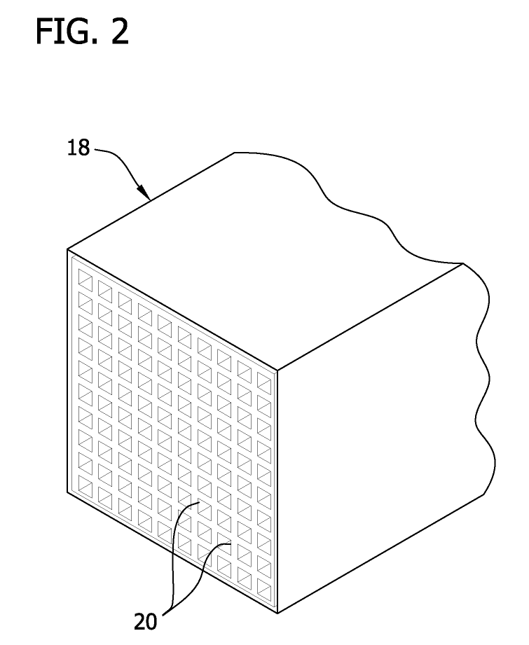

FIG. 3 is a perspective of a cleaning system showing a catalytic converter suspended above a tank of the cleaning system;

FIG. 4 is a section of the tank of the cleaning system;

FIG. 5 is a rear perspective of tank housing with the catalytic converter received in the tank;

FIG. 6 is an enlarged, fragmentary upper portion of the perspective of FIG. 5;

FIG. 7 is a section of the tank similar to FIG. 4 with the catalytic converter received in the tank and an air lance inside the tank directing pressurized fluid upward from beneath the catalytic converter;

FIG. 8 is a perspective of a lift-connector of the cleaning system;

FIG. 9 is an enlarged, fragmentary perspective of the lift-connector in FIG. 8; and

FIG. 10 is a flow chart diagramming an exemplary method of cleaning the catalytic converter.

Corresponding reference characters indicate corresponding parts throughout the drawings.

### DETAILED DESCRIPTION OF THE DRAWINGS

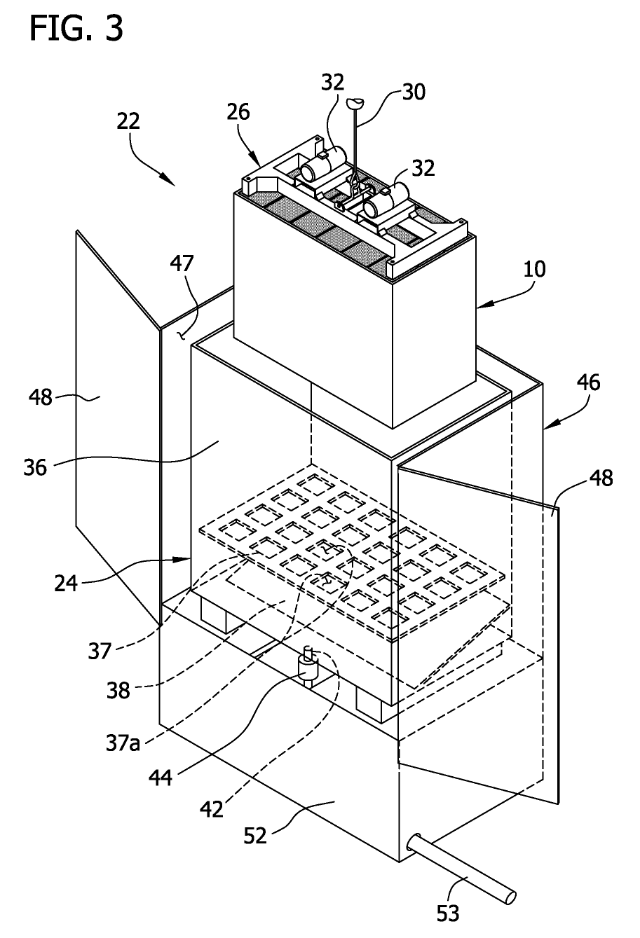

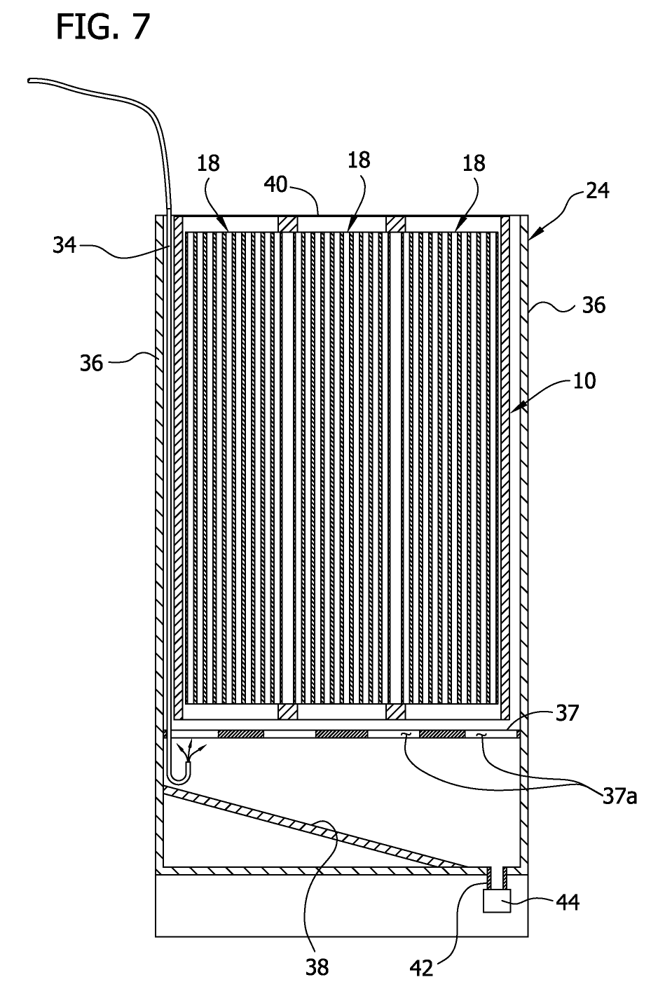

Referring now to the drawings and in particular to FIG. 3, a cleaning system for cleaning a catalytic converter 10 is generally indicated at 22. The cleaning system includes a tank, generally indicated at 24, for receiving cleaning liquid and a lift-connector, generally indicated at 26, for attaching the catalytic converter 10 to a lift device, such as a forklift (not shown) or a crane (the cable attachment of the crane is indicated at 30 in the drawings), to deliver the converter into the tank. As explained in more detail below, the cleaning system 22 also generally includes a pair of vibrators 32 secured to the lift-connector 26 and an air lance 34 (broadly, a liquid agitator; FIG. 7) for agitating the liquid in the tank 24.

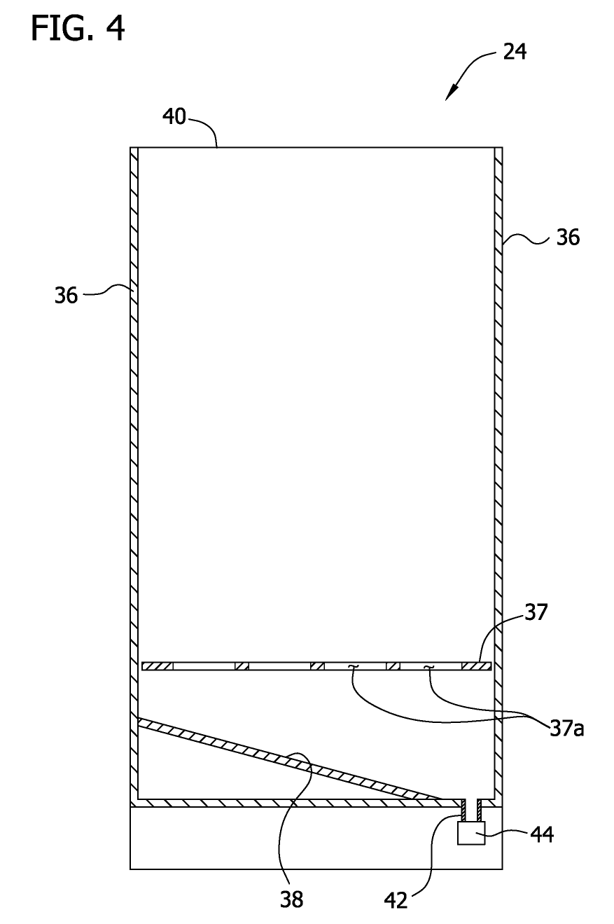

Referring to FIGS. 3 and 4, the tank 24 has four side walls 36, a floor 38 and an open top 40. A grating 37 (broadly, a porous support) in the tank is disposed above the floor 38. Referring to FIG. 7, the grating 37 is constructed to support the converter 10 when the converter is placed in the tank 24. The grating 37 includes a plurality of holes 37a to allow liquid and contaminants from the converter 10 to flow through the grating to the floor 38 of the tank 24. The tank 24 is sized and shaped to receive the catalytic converter 10 when the catalytic converter is oriented so that the catalyst channels 20 are generally vertical (i.e., where one of the open ends 16 constitutes a top of the converter). More specifically, the tank 24 is sized and shaped so that when the converter 10 rests on the grating 37 in the tank, the converter may be substantially completely submerged in the cleaning liquid held in the tank. Although less preferred, the converter 10 could be less than fully submerged when in the tank without departing from the scope of the present invention. An outlet 42 extends through the floor 38 of the tank 24 to allow liquid to exit the tank after cleaning. A valve 44, such as a ball valve, can be used to selectively open and close the outlet. The floor 38 of the tank 24 slopes downward at an angle toward an opening of the outlet 42 to facilitate removal of contaminants suspended in the cleaning liquid after cleaning.

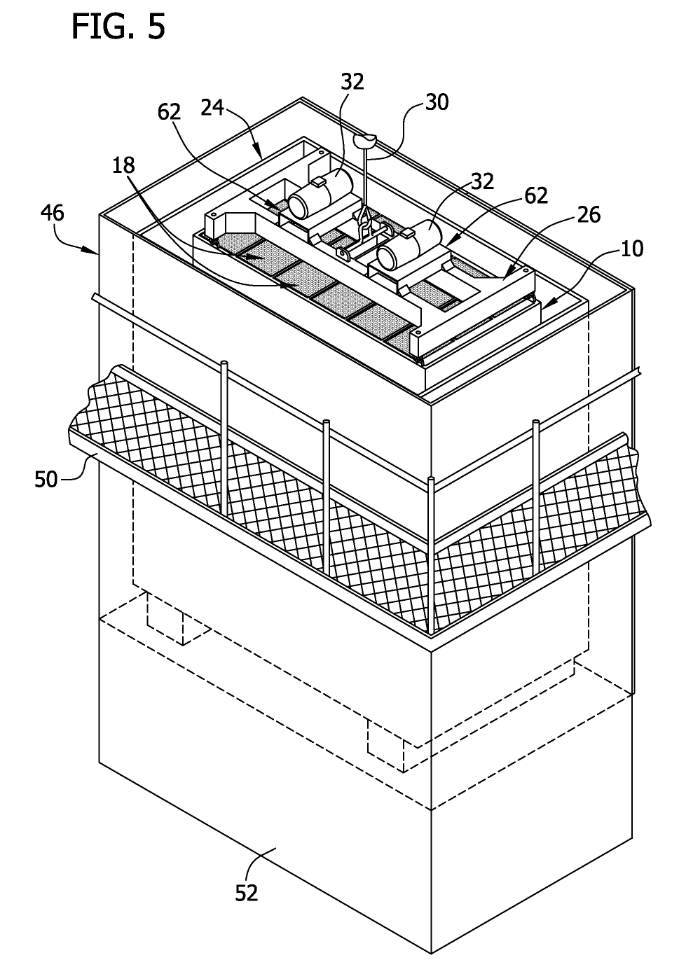

Referring back to FIG. 3, the tank is supported in a tank housing, generally indicated at 46. The tank housing defines a chamber 47 for receiving the tank and a pair of doors 48 at a front of the tank housing opening to the space. Referring to FIG. 5, the tank housing 46 also includes a platform 50 at a backside of the housing generally adjacent to an open, upper portion of the tank housing. The platform 50 is used to support an operator at or slightly above the one of the open, upper portion of the tank housing 46 and the tank 24 so that the operator can add surfactant to the cleaning liquid in the tank, as will be explained below, and can operate the air lance 34 (FIG. 7). The tank housing 46 also includes a large reservoir 52 situated below the tank 24, more specifically below the outlet 42 of the tank, when the tank is in the chamber of the housing for receiving the “dirty” liquid from the outlet when the tank is being drained. The purpose of the tank housing 46 is to elevate the tank 24 above the reservoir 52. Piping 53 (FIG. 3) fluidly connects the reservoir 52 to a contaminants pond (not shown) where the dirty water in the reservoir is delivered.

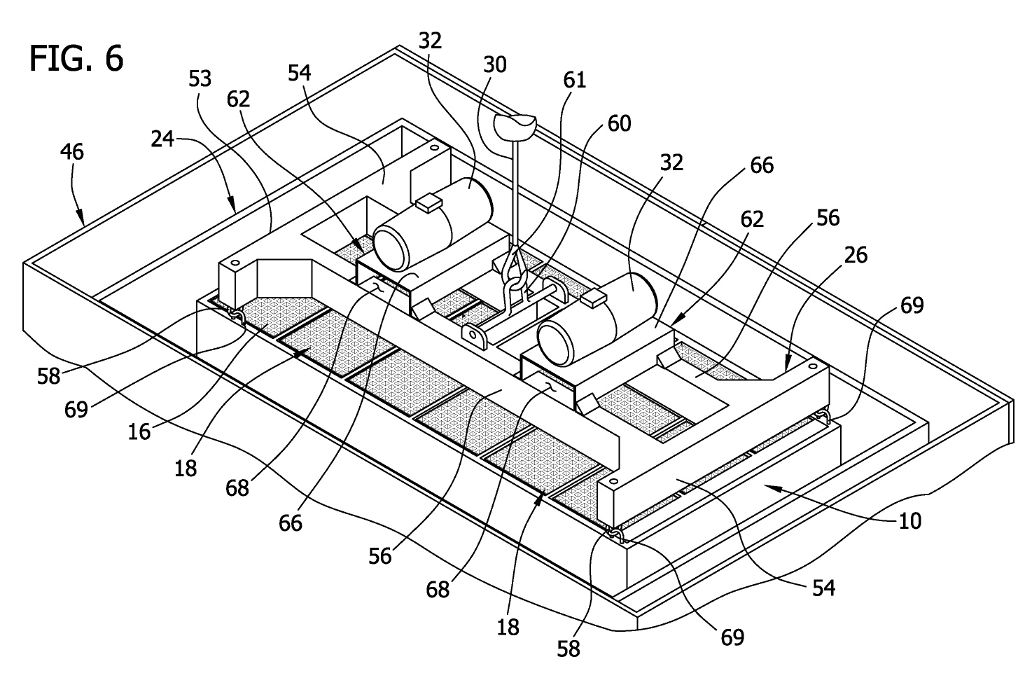

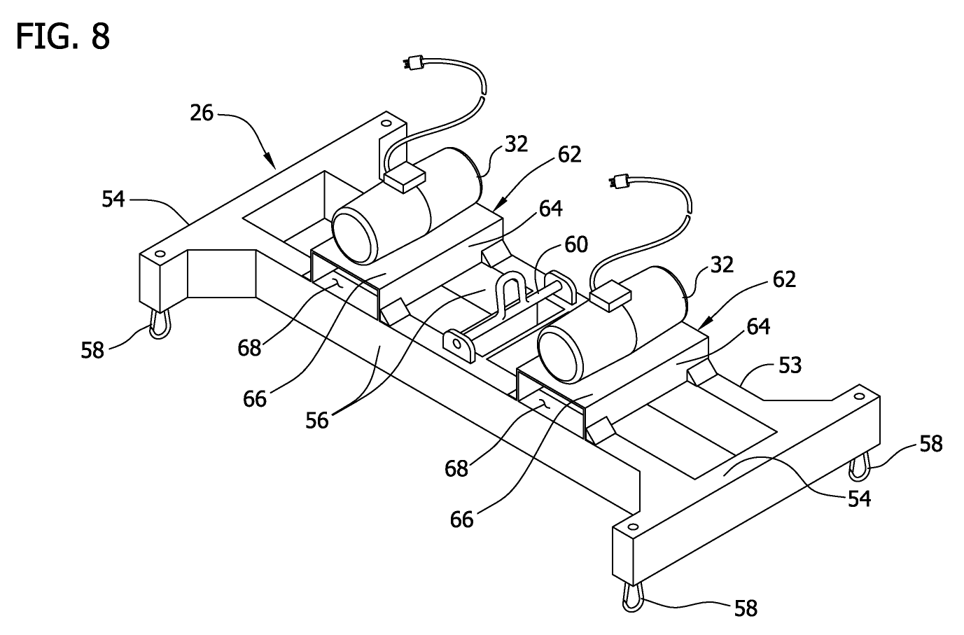

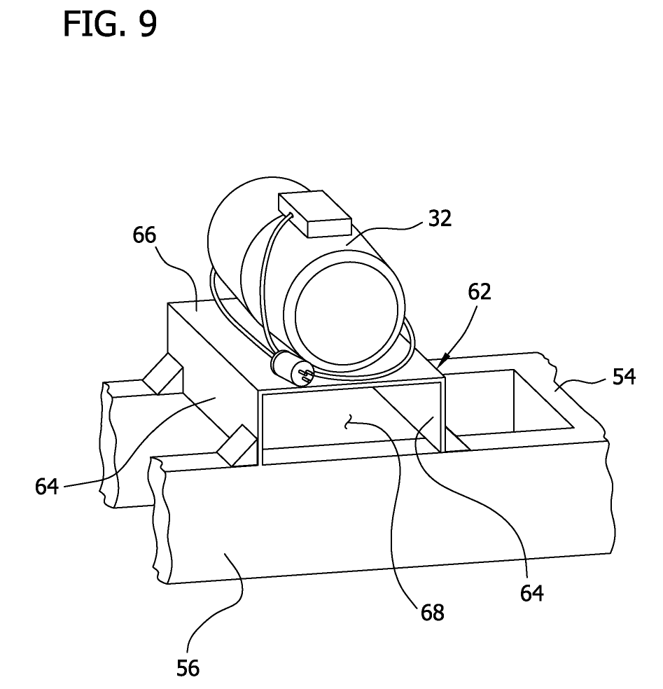

Referring to FIGS. 6, 8 and 9, the lift-connector 26 comprises a generally I-shaped fixture 53 formed by a pair of opposite, generally parallel side beams 54 and a pair of generally parallel cross beams 56 extending between the side beams. The lift-connector 26 also includes two different transporter-connection devices. A first bracket 60 (broadly, a first transporter-connection device) for receiving a hook 61 at the end of the cable 30 of the crane (or a like lift device) is mounted on a central area of the fixture 53. It is contemplated that the bracket may take a number of forms, including a screw pin anchor shackle. In addition, a pair of second brackets, generally indicate at 62, (broadly, a second transporter-connection device) are secured to an upper surface of the fixture 53. Referring to FIGS. 8 and 9, each second bracket 62 includes opposing side walls 64 extending upward from an upper surface of the lift-connector 26 and a top 66 extending between the side walls. Each second bracket 62 defines a fork-opening 68 extending generally parallel to the side beams and sized and shaped for receiving a respective one of the forks of a forklift.

Referring to FIGS. 6 and 8, the lift-connector 26 includes four clasps 58 or other type of connectors extending downward from a bottom surface of the lift-connector 26 generally adjacent to opposite ends of each of the side beams 54. The clasps 58 releasably attach to U-shaped members 69 (FIG. 6) extending upward from the sidewalls 14 of the converter 10. For example, the U-shaped members 69 may be screw pin anchor shackles. The lift 26 device may be secured to the converter 10 in other ways within the scope of the present invention.

Referring to FIGS. 5 and 6-9, the vibrators 32 are secured to the tops 66 of the second brackets 62 such that the brackets also broadly constitute vibrator mounts in the illustrated embodiment. Mounts (not shown) could be separate from the second bracket 62 within the scope of the present invention. In use, as explained in more detail below, the vibrators 32 impart vibratory movement to the catalytic converter 10 when the converter is in the tank 24 to facilitate removal of the contaminants from the catalyst channels 20 of the converter. Each vibrator may produce force of between about 100 lbs force (445 N) and about 4100 lbs force (18,238 N), more preferably between about 100 lbs force (445 N) and about 2050 lbs force (9119 N), more preferably between about 100 lbs force (445 N) and about 1025 lbs force (4559 N). It has been found that a large amount of force, such as above 4100 lbs force (18,238 N) may damage the converter 10 to the point where it cannot function for its intended purpose. Accordingly, the force produced by each vibrator is preferably within a range that is effective for loosening contaminants while not damaging the converter. For example, a suitable vibrator is manufactured by Martin Engineering of Neponset, Ill. and sold under the name Martin® Motomagnetic® electric vibrators. A suitable model of the Martin® Motomagnetic® electric vibrators is model number CD-36-4100. This vibrator has a 3 phase motor with 2.2 horsepower and 3600 rpm and produces a maximum force of 4100 lbs force (18,238 N). The force produced is adjustable. The vibrator runs at 60 Hz. Other vibrators and other ways of producing vibration of the converter 10 may be used within the scope of this invention.

Referring to FIG. 7, the air lance 34 (broadly, liquid agitator) delivers pressurized air upward within the tank 24. Accordingly, the air lance 34 directs the cleaning liquid from below the converter through the catalyst channels. The air lance 34 is generally L-shaped or J-shaped and is manually operable. It is understood that the air lance 34 may be automatically operable. It is also understood that other ways of agitating the liquid other than an air lance are within the scope of the invention.

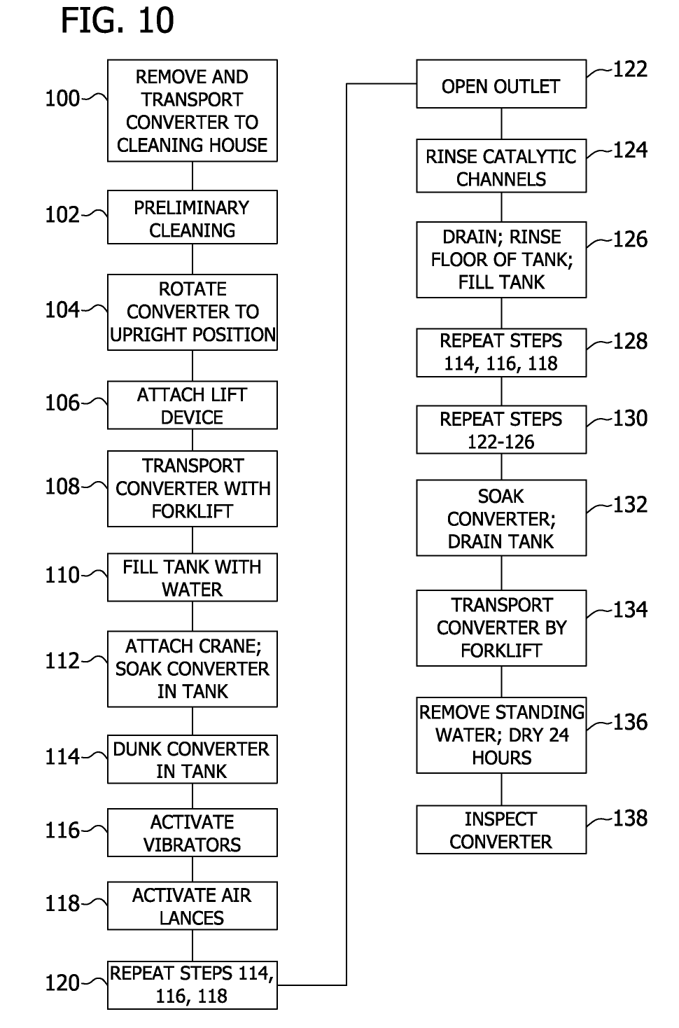

Referring now to FIG. 10, one example of a method of removing contaminants from a contaminated catalytic converter is broken down into steps or stages illustrated as a flow chart. At step 100, the converter 10 is removed from the power plant and transported to a cleaning house. Preliminary cleaning of the converter 10 may be performed at step 102 by scraping, brushing, and/or vacuuming the exterior of the housing and the exposed surfaces of the catalyst members (i.e., at the open exhaust and inlet ends of the housing) to remove contaminants, such as fly ash and popcorn ash, from the surfaces. The preliminary cleaning step may be performed before or after the catalyst converter 10 is transported to the cleaning house. Preferably, during preliminary cleaning the catalytic converter 10 is orientated so that the catalyst channels 20 extend generally horizontally.

At the cleaning house and after the preliminary cleaning step 102, at step 104 the converter 10 is rotated so that the catalyst channels extend generally vertically (i.e., upright position). In one example, the converter 10 is placed in a turntable device (not shown), which is a device generally known in the art that changes the orientation of the converter from the horizontal orientation to the vertical orientation, and vice versa. A forklift or other device may be used to place the converter 10 on a platform of the turntable device. With the converter 10 on the platform, a motor on the device is activated to rotate the platform 90 degrees about a horizontal axis. After rotating, the converter is orientated in the upright position.

With the converter 10 in the vertical orientation, at step 106 the lift-connector 26 is attached to the housing 12 of the converter 10 by securing the clasps 58 of the connector to the U-shaped members 69 on the converter. At step 108, the forks 70 of the forklift are inserted into the fork-openings 68 of the lift-connector 26, and the forklift lifts the converter 10 above the open top of the tank 24 and lowers the converter into the tank so that the converter rests on the grating 37 inside the tank. With the converter 10 resting on the grating 37, the forklift can be disengaged from the lift-connecter 26 by removing the forks of the forklift from the lift-connector. In one alternative, a crane (not shown) including the cable attachment 30 may be used to place the converter 10 in and remove it from the tank 24.

At step 110, the tank 24 is filled with filtered water, preferably having a pH of between about 6 and about 7, and a surfactant is added to the tank. In one example, 2-3 ounces of TERGITOL™ MiniFoam 1X surfactant (sold by The Dow Chemical Company) is added to the tank 24. The catalyst members 18 are preferably completely submerged in the water-surfactant mixture. The converter 10 is soaked in the tank (i.e., without agitation of the water-surfactant mixture or vibration of the converter) for preferably about 20 minutes. The cable attachment 30 of the crane is attached to the lift-connector 26 either before or during or after the converter has been soaked. After soaking for preferably about 20 minutes, at step 114 the crane lifts the converter 10 substantially completely out of the tank 24 and then lowers the converter back into the tank so that the catalyst members are once again completely submerged in the water. In effect, the crane “dunks” the converter 10 by lifting the converter out of the tank 26 and subsequently lowering the converter into the tank.

Once the catalyst members 18 are submerged, the vibrators 32 are activated at step 116 to impart vibratory movement to the converter 10 and facilitate loosening of contaminants in the catalyst channels. In one example, the vibrators 32 are activated for less than about 5 seconds, and preferably about 1 second. Although the vibrators 32 may be activated for a longer or shorter period of time, it has been found that vibrating the converter 10 for 1 second is sufficient to loosen contaminants in the catalyst channels 20 and makes it less likely that vibrations will damage the catalyst members 18.

After activation of the vibrators 32, the air lance 34 is activated at step 118 to create a flow of water (broadly, to agitate the water) from below the converter 10 and up through the catalyst channels 20 to remove contaminants loosened by the vibrators 32. For example, a distal portion of the air lance 34 may be inserted through the openings 37a of the grating 37 to agitate the water up through the catalyst channels 20. The air lance 34 may be manually operated and moved around the tank 24 for agitating the water near different converter members 18. It will be understood that more than one lance may be used and that the lance(s) may be in a fixed position on the tank 24 or moved automatically. The step 114 of dunking the converter (i.e., lifting the converter out of the tank 26 and subsequently lowering the converter into the tank), and the step 118 of activating the vibrators 116 and activating the air lances are repeated several times, and in one example, are repeated six times at step 120.

Upon completion of the last repetition and with the converter 10 in the tank 26, the outlet 42 of the tank 24 is opened at step 122 using the valve 44 to allow the “dirty” water containing the removed contaminants from the converter 10 to be drained out of the tank and into the reservoir 52. From the reservoir 52, the dirty water is delivered to a contaminant pond through the piping 53 connected to the reservoir. At step 124, the catalyst members 18 are then rinsed by directing water (having the proper pH between about 6 and about 7) from a high pressure hose into the open end 16 of the converter 10. After rinsing, the converter is removed from the tank and the floor is rinsed at step 126 to remove left over contaminants from the tank. The outlet 42 is then closed, the converter 10 is placed back in the tank 24, and the tank is filled with water having the proper pH between about 6 and about 7.

At step 128, the step 114 of dunking the converter 10 in the tank, the step 116 of activating the vibrators, and the step 118 of activating the air lances are again repeated several times, and in one example, are repeated six times. Then, at step 130 the tank 24 is drained, the catalyst members 18 are rinsed with the hose, the converter 10 is removed, the floor 38 of the tank is rinsed, the converter is place back in the tank and the tank is filled with water, such as described above, in steps 122-126. At step 132, the converter 10 is soaked in the tank 24 for at least about 5 minutes. After soaking, the outlet 42 of the tank 24 is opened and the water is drained from the tank.

At step 134, the converter 10 is detached from the crane 30 and the fork lift removes the converter 10 from the tank 24 and delivers it to the turntable device 74. The turntable device orientates the converter 10 so that its catalyst channels 20 extend generally horizontally. After orientation of the converter 10, the lift-connector 26 is removed. At step 136, dry, oil-free compressed air is used to remove standing and/or puddled water on or near the exterior of the housing 12 and exposed surfaces of the catalyst members 18 at the open ends 16 of the converter 10. The converter 10 is then allowed to dry for at least 24 hours.

At step 138, the converter 10 is inspected for cleanliness. In one example, as is generally known in the art, a light-colored, reflective surface is disposed about 10 feet from one of the ends (e.g., exhaust end) of the converter 10. Quartz lights (not shown) are positioned to direct light to the reflective surface, whereby the light is reflected off the surface toward the exhaust end of the converter. An inspector positioned on the inlet end of the converter randomly selects 6 catalyst logs for inspection. For each selected log, the supervisor inspects each catalyst channel by determining whether light reflected off of the reflective surface is traveling through the channel, whereby it can be determined that the channel is clear of contaminants. In one example, if at least 90% (e.g., 436 out of 484 channels) of the catalyst channels in each of the 6 catalyst logs are clear, then the converter passes inspection. The converter can then be reused. If the converter fails inspection, the cleaning process is repeated, unless it is determined that the converter cannot be effectively cleaned.

Having described the illustrated embodiment in detail, it will be apparent that modifications and variations are possible without departing from the scope of the invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A device for use in cleaning a catalytic converter of the type used in power plants, the device comprising:
a fixture adapted for securement to the catalytic converter;
a vibrator mounted on the fixture for imparting vibratory movement to the fixture and to the converter when the fixture is secured to the converter.

2. A device as set forth in claim 1 further comprising a vibrator mount on the fixture, the vibrator being mounted on the vibrator mount.

3. A device as set forth in claim 2 wherein the vibrator constitutes a first vibrator and the vibrator mount constitutes a first vibrator mount, and wherein the device further comprises a second vibrator mount spaced apart from the first vibrator, and a second vibrator mounted on the second vibrator mount.

4. A device as set forth in claim 3 wherein the first and second vibrator mounts each define a fork passage for receiving forks of a forklift.

5. A device as set forth in claim 4 further comprising a transporter-connection device for connecting the fixture to a crane.

6. A lift-connector for use in securing a catalytic converter of the type used in power plants to a forklift, the lift-connector comprising:
fixture adapted to secure the catalytic converter to the lift device for use in lifting the catalytic converter;
a pair of spaced apart fork-openings defined by the fixture, each fork-opening being sized and shaped for receiving a fork of a forklift.

7. A lift-connector as set forth in claim 6 further comprising plural vibrators secured to the fixture.

8. A lift-connector as set forth in claim 7 further comprising a transporter-connection device for connecting the device to a crane.

9. A cleaning system for removing contaminants from a catalytic converter comprising:
a tank for holding cleaning liquid, the tank being sized and shaped to allow a catalytic converter to be placed in the liquid in the tank;
a vibrator adapted for operative connection with the converter to impart vibratory movement to the converter when the converter is placed in the liquid of the tank to facilitate removal of the contaminants from the converter.

10. A cleaning system as set forth in claim 9 further comprising at least one air lance for forcing fluid under pressure through the catalytic converter in the tank.

11. A cleaning system as set forth in claim 9 wherein the tank includes a porous support for supporting the catalytic converter within the tank and providing access to a bottom side of the converter in the tank.

12. A cleaning system as set forth in claim 9 wherein the vibrator constitutes a first vibrator, and wherein the cleaning system further comprises a second vibrator adapted for operative connection with the catalytic converter.

13. A cleaning system as set forth in claim 12 further comprising a fixture adapted for securement to the converter, the first and second vibrators being mounted on the fixture.

14. A method of removing contaminants from a catalytic converter having catalyst members defining a plurality of catalyst channels, the method comprising:
placing the catalytic converter in a tank of liquid;
vibrating the catalytic converter placed in the tank to loosen the contaminants from within the catalyst channels.

15. A method of removing contaminants from a catalytic converter as set forth in claim 14 further comprising agitating the liquid in the tank.

16. A method of removing contaminants from a catalytic converter as set forth in claim 14 wherein agitating the liquid occurs subsequent to vibrating the catalytic converter.

17. A method of removing contaminants from a catalytic converter as set forth in claim 14 wherein vibrating the catalytic converter is carried out for a period of less than about 5 seconds.

18. A method of removing contaminants from a catalytic converter as set forth in claim 17 wherein vibrating the catalytic converter is carried out for a period of about 1 second.

19. A method of removing contaminants from a catalytic converter as set forth in claim 14 further comprising lifting the converter substantially completely out of the tank of liquid and lowering the converter back into the tank of liquid.
